(19) United States
(12) Patent Application Publication
(10) Pub. No.: US 2023/0413888 A1
(43) Pub. Date: Dec. 28, 2023

(54) EDIBLE BLOOD COMPOSITIONS AND RELATED METHODS

(71) Applicant: EdibleFX LLC, Decatur, GA (US)

(72) Inventor: Elizabeth GROVE, Decatur, GA (US)

(73) Assignee: EdibleFX LLC, Decatur, GA (US)

(21) Appl. No.: 18/340,496

(22) Filed: Jun. 23, 2023

Related U.S. Application Data
(60) Provisional application No. 63/373,744, filed on Aug. 29, 2022.
(60) Provisional application No. 63/355,214, filed on Jun. 24, 2022.

(51) Int. Cl. A23L 35/00; A23L 29/206; A23L 33/125; A23L 3/02

(52) U.S. Cl. CPC A23L 35/00; A23L 3/02; A23L 33/125; A23L 29/206

(57) ABSTRACT

Edible blood compositions and methods of preparation and uses thereof are described. The method may include preparing an aqueous hibiscus solution; preparing a mixture of cornstarch and cherry juice concentrate; heating the aqueous hibiscus solution; adding cocoa powder to the aqueous hibiscus solution; combining the mixture of cornstarch and cherry juice concentrate with the mixture of the aqueous hibiscus solution and the cocoa powder to form a combined mixture; adding a nutritive sweetener to the combined mixture; allowing the combined mixture to reach a boiling point to activate the cornstarch; and cooling the mixture after a desired consistency and color are obtained to prepare the edible blood composition. An animal edible blood composition may be prepared using water, tart concentrate, and tart cherry juice concentrate.

### CROSS-REFERENCE TO RELATED APPLICATIONS

This application claims priority to U.S. Provisional Application No. 63/355,214, filed on Jun. 24, 2022, and U.S. Provisional Application No. 63/373,744, filed on Aug. 29, 2022, the entireties of each of which are incorporated herein by reference.

### TECHNICAL FIELD

The present disclosure relates generally to edible blood products and related methods of preparation and use. More specifically, the present disclosure includes edible blood compositions made from clean ingredients and having a realistic blood-like appearance and consistency. The present disclosure includes edible blood compositions for humans and also edible blood compositions for animals such as dogs.

### BACKGROUND

Artificial blood (e.g., fake blood) compositions are used throughout the entertainment and special effects industries to replicate real blood. While a variety of fake blood compositions exist in both inedible and edible form, many of these compositions do not provide a realistic blood-like appearance, especially when captured on camera. Existing fake blood compositions may have an unrealistic color (e.g., too light or too dark), an unrealistic consistency (e.g., runny, too thin, or too thick), and/or an unrealistic texture (e.g., grainy or sticky).

Commonly used ingredients in edible blood products include corn syrup and red food coloring, as well as other artificial ingredients and/or chemical preservatives. However, some people are not able to consume these compositions due to dietary restrictions, digestion concerns, allergies, or aversion. Further, commonly used edible blood ingredients may not be conducive for repeated consumption when filming multiple takes in a production. Another concern is that certain ingredients used to achieve the color of fake blood compositions, such as food dye and beets, leave behind a stain, which may be difficult to remove from the body (e.g., teeth) and/or clothing.

### SUMMARY

The present disclosure includes edible blood compositions and methods of preparation and use. For example, the present disclosure includes a method for preparing an edible blood composition, the method comprising: preparing an aqueous hibiscus solution; preparing a mixture of a thickening agent selected from cornstarch, tapioca starch, and tapioca flour and cherry juice concentrate; heating the aqueous hibiscus solution; adding cocoa powder to the aqueous hibiscus solution; combining the mixture of the thickening agent and cherry juice concentrate with the mixture of the aqueous hibiscus solution and the cocoa powder to form a combined mixture; adding a nutritive sweetener to the combined mixture; allowing the combined mixture to reach a boiling point to activate the thickening agent; and cooling the mixture after a desired consistency and color are obtained to prepare the edible blood composition. The method may further comprise applying agitation after each step of adding an ingredient and combining mixtures. For example, applying agitation may comprise stirring, whisking, or a combination thereof. Each step of adding cocoa powder, combining mixtures, and adding a nutritive sweetener may be performed under heating. In some examples, the nutritive sweetener comprises honey or agave. In some aspects of the present disclosure, the method may further comprise adding additional thickening agent and/or cherry juice concentrate to the combined mixture to obtain the desired consistency and color for the edible blood composition.

In at least one example, cooling the mixture may comprise placing a container retaining the edible blood composition in an ice bath. In certain aspects of the present disclosure, preparing an aqueous hibiscus solution may include: combining water and hibiscus flowers; heating the combined water and hibiscus flowers to a boiling point; allowing the combined water and hibiscus flowers to simmer for at least 15 minutes; separating an aqueous component from the hibiscus flowers and any free particles; and retaining the aqueous component for the aqueous hibiscus solution. For example, separating may be performed with a filter, a fine strainer, or a cheese cloth. In some examples, preparing the mixture of the thickening agent and cherry juice concentrate may comprise sifting the thickening agent onto the cherry juice concentrate and allowing the mixture to sit for about 5 minutes to about 20 minutes.

Combining the mixture of the thickening agent and cherry juice concentrate with the mixture of aqueous hibiscus solution and the cocoa powder may comprise sifting the mixture of the thickening agent and cherry juice concentrate into the mixture of aqueous hibiscus solution and cocoa powder, and continuously stirring and whisking the combined mixture. Each step of adding the cocoa powder, combining mixtures, and adding the nutritive sweetener may occur before the boiling point is reached. Furthermore, the method may further comprise: packaging the edible blood composition in a container that is capable of maintaining a shelf life of at least 10 days.

The present disclosure also includes an edible blood composition comprising: hibiscus flowers; water; dark cocoa powder; cornstarch; cherry juice concentrate; and a nutritive sweetener selected from honey, brown rice syrup, and agave. In some examples, the composition may comprise 3 to 4 cups hibiscus flowers; 1 gallon of water; 1 teaspoon dark cocoa powder; from about 9 tablespoons to about 10 tablespoons cornstarch; from about 2 to 3 cups cherry juice concentrate; and 8 to 10 tablespoons honey. In other examples, the composition may comprise 3 cups hibiscus flowers; 1 gallon of water; 1 teaspoon dark cocoa powder; from about 9 tablespoons to about 10 tablespoons cornstarch; from about 2 to 3 cups cherry juice concentrate; and 8 to 10 tablespoons agave. In other examples, the composition may comprise 10 ounces hibiscus flowers, wherein the hibiscus flowers are dried hibiscus flowers; 4 cups of water; ¼ teaspoon dark cocoa powder; 4 tablespoons tapioca flour; from about 2 to 3 cups cherry juice concentrate, wherein the cherry juice concentrate is condensed cherry juice; and 6 tablespoons agave or 6 tablespoons brown rice syrup. The edible blood composition may have a viscosity that mimics real blood in a range of about 3 centipoises to about 4 centipoises.

In some aspects of the present disclosure, the edible blood composition may be capable of preventing a stain from forming on teeth upon consumption. In at least one example, a method for preventing staining of teeth in a subject may comprise: applying the edible blood composition to teeth and wiping the edible blood composition from the teeth, wherein no trace of the edible blood composition is detected on the teeth after wiping.

Another aspect of the present disclosure may include a method of extending a shelf life of the edible blood composition. The method may comprise: packing the edible blood composition in a packaging material suitable for undergoing a preservation process; and subjecting the packaging to heat treatment, wherein the shelf life is extended by about 6 to about 11 months.

Also included in the present disclosure is a method for preparing an animal edible blood composition. The method may comprise: preparing a concentrate solution from 1 cup of alkaline water, 2 cups of tart concentrate, and 2 cups of tart cherry juice concentrate; heating the concentrate solution; reducing the heat when heating the concentrate solution results in a boil; simmering the boiled solution; and cooling the simmered solution to prepare the animal edible blood composition. In some examples, simmering the boiled solution comprises simmering the solution for between approximately 22 minutes and approximately 28 minutes. The method may further include adding an animal attractor to the animal edible blood composition. For example, the animal attractor may be one or more of a meat product, an oatmeal product, or a fruit. In some examples, the method may further comprise adding cornstarch to the animal edible blood composition comprising the animal attractor.

It is to be understood that both the foregoing general description and the following detailed description are exemplary and explanatory only and are not restrictive of the claims.

### BRIEF DESCRIPTION OF THE DRAWINGS

The accompanying drawing, which is incorporated in and constitutes a part of this specification, illustrates exemplary embodiments and together with the description, serves to explain the principles of the disclosed embodiments.

FIG. 1 depicts a flowchart for preparing an edible blood composition according to one or more embodiments of the present disclosure.

FIG. 2 depicts images of an edible blood product produced according to an embodiment of the present disclosure.

FIG. 3 depicts images of application and removal an edible blood product according to an embodiment of the present disclosure.

FIG. 4 depicts a flowchart for preparing an edible blood composition according to one or more embodiments of the present disclosure.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ±10% of a specified amount or value. All ranges are understood to include endpoints, e.g., a concentration from 2 cups to 3 cups, includes 2 cups, 3 cups, and all values between.

Embodiments of the present disclosure include edible blood compositions and processes for preparing and/or storing edible blood compositions. The edible blood compositions of the present disclosure may mimic properties of real blood, with respect to appearance (e.g., color) and consistency. The edible blood compositions are prepared from ingredients that may provide healthier options and nutritional benefits, while maintaining palatability, as compared to known edible blood compositions. The edible blood compositions may also prevent staining (e.g., staining of teeth, staining of skin, staining of clothes, etc.) and allow for repeated consumption and/or use, as compared to existing edible blood compositions.

The edible blood compositions of the present disclosure may comprise hibiscus flowers, water, cocoa powder, a thickening agent (e.g., cornstarch, tapioca flour, or tapioca starch), cherry juice concentrate, and a nutritive sweetener selected from honey and agave. Such edible blood compositions may be suitable for human and/or animal consumption. Each of the ingredients contribute to the color and/or consistency of the edible blood composition and may assist in preparing a composition that mimics certain properties of real blood. In addition, many of the ingredients provide the edible blood composition with nutritive properties and address dietary concerns. Hibiscus flowers, which come in a variety of bright colors, including various shades of red and pink, may be used as a colorant in the edible blood composition. Exemplary hibiscus flowers for use in the composition may include darker colored hibiscus flowers, which may provide a deep red color for the blood. It has also been discovered that the presence of hibiscus flowers may contribute to the ability of the edible blood composition to not leave a stain. Water may be combined with the hibiscus flowers to extract the color.

Other ingredients that may contribute to the color of the edible blood composition include the cocoa powder and the cherry juice concentrate. In at least some embodiments, a dark cocoa powder may be used. The cherry juice concentrate may be concentrated from tart cherries and may be gluten free. In addition to contributing to the color of the edible blood composition, the cherry juice concentrate as well as the hibiscus, may provide antioxidants to the composition. The thickening agent (e.g., cornstarch) may contribute to the thickness of the edible blood composition. The nutritive sweetener in the form of honey (e.g., Manuka honey) may also contribute to consistency as well as the taste of the edible blood composition. The present disclosure also includes an alternative edible blood composition wherein the honey may be substituted for agave, in order to provide a vegan option.

The edible blood compositions of the present disclosure may have a shelf-life of about 10 days under refrigerated conditions. However, the edible blood compositions may be further processed to extend the shelf life. In at least one example, the edible blood composition may be prepared on a weight basis of 1 gallon. The composition may comprise 1 gallon water, 3 cups hibiscus flowers, 1 teaspoon cocoa powder, from about 9 tablespoons to about 10 tablespoons cornstarch, from about 2 cups to about 3 cups cherry juice concentrate, and 8 tablespoons honey. Other concentrations of each ingredient may also be used to prepare the edible blood composition. The edible blood compositions of the present disclosure may also have a viscosity in the range of about 3 centipoises to about 4 centipoises, which mimics the viscosity of real blood. It will be understood that although the example edible blood composition provided above is based on a weight basis of 1 gallon, any weight basis may be used to produce the edible blood composition. A different weight basis may require using proportionate amounts of the items disclosed herein, relative to the weight basis of 1 gallon.

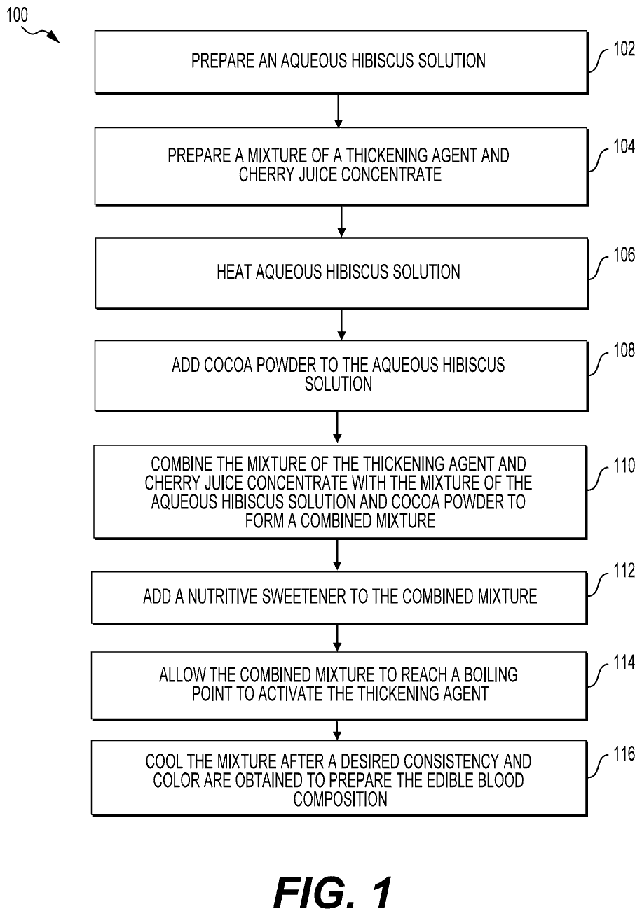

FIG. 1 is an exemplary embodiment of a flowchart illustrating a method 100 for preparing an edible blood composition.

In step 102, an aqueous hibiscus solution is prepared. The aqueous hibiscus solution may be prepared by extracting hibiscus juice or liquid comprising hibiscus color from Hibiscus flowers. In order to obtain the aqueous hibiscus solution, water and hibiscus flowers are combined. In some examples, the water may be filtered water. Intact hibiscus flowers or portions of hibiscus flowers may be combined with the water. For example, hibiscus petals or leaves may be used to prepare the aqueous hibiscus solution. When intact hibiscus flowers are gathered, the petals may be removed and used to prepare the aqueous hibiscus solution. The hibiscus flowers may be dried or fresh. Once the water and hibiscus flowers are combined the mixture may be heated to boiling at approximately 100° C. After the boiling point is reached, the temperature may be reduced to a simmer between approximately 85° C. to approximately 96° C. Simmering may occur for a period of about 15 minutes to about 25 minutes. The time and temperature during the preparation of the hibiscus solution may vary to allow for sufficient extraction of color.

After the hibiscus flowers have simmered in the water, the solid hibiscus materials (e.g., petals, flowers, hibiscus particles, particulates) may be removed or separated from the liquid comprising the extracted hibiscus color. Suitable methods for separating the solid hibiscus material from the aqueous hibiscus solution include, but are not limited to filtration, sieving, and straining. For example, a fine strainer or a cheese cloth may be used to strain the solid hibiscus materials out of the aqueous solution. The resultant aqueous solution comprises a color (e.g., red color) extracted from the hibiscus flowers.

In step 104, a mixture of a thickening agent (e.g., cornstarch) and cherry juice concentrate is prepared. The cherry juice concentrate may comprise approximately 100% cherry juice. The cherry juice concentrate may be concentrated from Montmorency cherries and reconstituted with water. In some examples, the thickening agent may be selected from cornstarch, tapioca flour, and tapioca starch. The thickening agent (e.g., cornstarch) may be added to the cherry juice concentrate in a manner that reduces clumping of the thickening agent. For example, the thickening agent (e.g., cornstarch) may be sifted onto the cherry juice concentrate. As the thickening agent is added to the cherry juice concentrate (e.g., via sifting), the mixture may be stirred or otherwise agitated to adequately mix the cornstarch and cherry juice concentrate together. Preparing the thickening agent (e.g., cornstarch) and cherry juice concentrate may also include allowing the mixture to sit for a period of time. Letting the mixture of the thickening agent and cherry juice concentrate sit for a period of time allows the thickening agent to be darkened by the cherry juice concentrate. The mixture of thickening agent and cherry juice concentrate may sit for at least approximately 5 minutes. For example, the mixture may be left to sit for approximately 5 minutes to approximately 20 minutes. In some examples, the mixture of the thickening agent and cherry juice concentrate may be prepared while the aqueous hibiscus solution is being prepared, such as during the simmering of the hibiscus flowers in the water. Accordingly, steps 102 and 104 may be performed at substantially the same time. Alternatively, the mixture of the thickening agent and cherry juice concentrate may be prepared first and be left to sit while the aqueous hibiscus solution is being prepared in accordance with step 102.

In step 106, the aqueous hibiscus solution prepared in step 102 is heated. The aqueous hibiscus solution may be heated to temperatures below the boiling point. Heating the aqueous hibiscus solution comprises adding the aqueous solution back to heat (i.e. applying heat) after step 102. A suitable heating temperature range may include a range from approximately 85° C. to approximately 95° C.

Step 108 includes adding cocoa powder to the aqueous hibiscus solution of step 106, while the solution is being heated. For the purposes of the present disclosure, cocoa powder and cacao powder may be used interchangeably. The cocoa powder added may preferably be dark cocoa powder (e.g., Dutch processed cocoa powder or black cocoa powder). The dark cocoa powder/dark cacao powder may be prepared from natural cocoa powder. The natural cocoa powder may be treated with an alkaline solution or alkalized to obtain the dark cocoa powder. The cocoa powder is introduced to the aqueous hibiscus solution, under heating, but before the solution is brought to a boil. As the cocoa powder is added to the aqueous hibiscus solution, the mixture may be stirred or otherwise agitated to adequately mix the cocoa powder and the aqueous hibiscus solution together. The stirring may be continuous. Upon mixing the aqueous hibiscus solution and the cocoa powder together, a deep reddish brown color may be observed. Exemplary colors which may be observed include dark red colors similar to or corresponding to HEX color #800020, HEX color #4C1C24, HEX color #73343A, HEX color #A01641, and HEX color #701f28. It will be understood that the color after step 108 may be similar to or different than the color of a final product (e.g., after step 116).

In step 110, the mixture of the thickening agent (e.g., cornstarch) and cherry juice concentrate, prepared in step 104, is added to the mixture of aqueous hibiscus solution and cocoa powder. A combined mixture is formed by combining the thickening agent/cherry juice concentrate mixture prepared in step 104 with the aqueous hibiscus/cocoa powder mixture prepared in step 108. Combining the thickening agent/cherry juice concentrate mixture with the aqueous hibiscus/cocoa powder mixture may result in a deepening of the color observed upon mixing the aqueous hibiscus solution and the cocoa powder (e.g., dark cocoa powder) in step 108. The mixture of thickening agent and cherry juice concentrate is introduced to the mixture of aqueous hibiscus solution and cocoa powder, before the boiling point of the aqueous hibiscus solution, which is heated in step 106, is reached. The thickening agent/cherry juice concentrate mixture may be added to the aqueous hibiscus/cocoa powder mixture in a manner that reduces an introduction of clumps that may have formed after the preparation of the thickening agent/cherry juice concentrate mixture in step 104, which comprises combining the thickening agent (e.g., cornstarch) and cherry juice concentrate and allowing the mixture to sit for a period of time. For example, the thickening agent/cherry juice concentrate mixture may be sifted into the aqueous hibiscus/cocoa powder mixture. As the thickening agent/cherry juice mixture is added to the aqueous hibiscus/cocoa powder mixture, the mixtures may be stirred or otherwise agitated to facilitate adequate mixing. In some examples, the combined mixture may be stirred and whisked. The stirring and whisking may be continuous.

During step 110, the conditions under which the thickening agent/cherry juice concentrate mixture and the aqueous hibiscus/cocoa powder mixture are combined may be monitored for the formation of bubbles. Adjustments may be necessary to remove any bubbles that form during the step of combining the cornstarch/cherry juice concentrate mixture with the aqueous hibiscus/cocoa powder mixture to obtain a realistic blood-like appearance. For example, additional stirring and/or whisking may be required to remove bubbles. Another option for reducing bubble formation, is to slightly reduce the heating temperature at which the mixtures are combined.

In step 112, a nutritive sweetener is added to the combined mixture obtained in step 110. A nutritive sweetener may provide flavoring and nutritive components to the edible blood composition. The nutritive sweetener added in step 112 may make the composition more palatable. Any suitable nutritive sweetener may be added in step 112. In some examples, the nutritive sweetener may be honey. A suitable source of honey is Manuka honey. In other examples, the nutritive sweetener may be agave nectar or agave syrup. Any source of agave may be suitable for use as the nutritive sweetener, including, but not limited to, Agave tequilana (blue agave), Agave salmiana, and Agave americana. The agave may be used as a substitute for honey (e.g., Manuka honey), to provide a vegan option for the edible blood composition. Other suitable nutritive sweeteners include maple powder, maltose and brown rice syrup. The amount and/or type of nutritive sweetener added may be varied or adjusted to obtain a desired viscosity of the edible blood composition. For example, honey or brown rice syrup may be used instead of agave when a more viscous nutritive sweetener is desired. The nutritive sweetener may be introduced to the combined mixture, under heating, but before the combined mixture is brought to a boil. As the nutritive sweetener is added to the combined mixture, the mixture may be stirred or otherwise agitated to adequately mix the nutritive sweetener and the combined mixture together. Additionally or alternatively, the nutritive sweetener may be added during a different step in method 100 other than step 112. In some examples, the nutritive sweetener may be added at step 108. In other examples, the nutritive sweetener may be added at the end of the process or following a later step in method 100. For example, the nutritive sweetener may be added after step 114 described in further detail below. In some examples, the entire amount of nutritive sweetener may be added in step 112. In other examples herein, at least a portion of the nutritive sweetener may be added after step 114 depending on the desired sweetness of the final product. In at least one example, the entire amount of nutritive sweetener may be added after step 114.

Step 114 includes boiling the combined mixture obtained from step 112. The combined mixture comprising the thickening agent (e.g., cornstarch), cherry juice concentrate, aqueous hibiscus solution, cocoa powder, and nutritive sweetener (e.g., Manuka honey, brown rice syrup, or agave) is heated to a boil at approximately 100° C. The heat is raised and the combined temperature is brought to a boil in order to activate the cornstarch. Activating the thickening agent allows the thickening agent to thicken within the mixture. In order to activate the thickening agent (e.g., cornstarch) and thicken the combined mixture comprising the thickening agent, the combined mixture may be brought to a boil (e.g., heated to approximately 100° C.) and then brought to a simmer, in a range of approximately 85° C. to approximately 96° C., until a desired thickness is achieved. The boiling and simmering may occur for a total of approximately 5 minutes or less. In some examples, the heating portion of step 114, may conclude just as the combined mixture is brought to a boil or reaches its boiling point. For example, the combined mixture may be removed from heating or the temperature may be cut off, when the combined mixture is almost at a boil or just when boiling is reached to prevent the thickening agent in the combined mixture from breaking down.

Once the thickening agent (e.g., cornstarch)/cherry juice concentrate mixture and the aqueous hibiscus/cocoa powder mixture as well as the nutritive sweetener (if added prior to step 114) are adequately mixed together, such as by stirring and/or whisking, and the combined mixture is heated almost to a boil (e.g., right before reaching the boiling point), the combined mixture may be strained. For example, the combined mixture may be strained at least one time (e.g., two times) through a sieve to ensure that the combined mixture for the edible blood composition appears smooth and is free from particles. A fine sieve may be used to perform the straining.

Step 114 may also include observing or monitoring the mixture to determine when a desired consistency and color are achieved. For example, the mixture may be stirred and/or ladled to determine whether the mixture is too thin or runny and whether there has been sufficient thickening. A desired consistency of the mixture may be thicker than liquids such as water and juice and thinner than liquids or semi-liquids such as gravy and sauce. The mixture may be characterized by a consistency wherein upon moving a container comprising the mixture in a circular motion, the composition rolls around the container without splashing out of the container. The mixture may also be observed for a desired color. The desired consistency and color obtained for the edible blood composition should mimic the consistency and color of real blood. Additional dark cocoa powder may be added to deepen or darken the color. For example, if the color of the edible blood composition appears too pink, adding additional dark cocoa powder, such as a pinch of dark cocoa powder, may deepen the color. When the consistency of the mixture is determined to be too thin (e.g., watery or runny), additional thickening agent may be added to thicken the mixture. Heating may also be adjusted or raised to aid in thickening the additional thickening agent in the mixture. Additional thickening agent (e.g., cornstarch) may also be added to lighten the color of mixture, when the color is determined to be too dark. In some examples, additional thickening agent (e.g., cornstarch) may be added for both thickening and lightening purposes. For example, additional thickening agent (e.g., cornstarch) may be added to thicken the consistency of the mixture, while also lightening (e.g., brightening) the color of the mixture. In other examples, it may be desirable to lighten the color of the mixture, without adding more thickening agent. In these examples, additional cherry juice concentrate, such as 1 cup of cherry juice concentrate, may be added to lighten the color of the mixture. According to an example implementation, the color may be or may be similar to natural blood color such as a HEX color #610c0c, HEX color #5f0c00, HEX color #781601, and/or the like. When additional thickening agent is added, the mixture may be strained after the addition and mixing in of the thickening agent to remove any clumps formed and to obtain a smooth appearance and consistency. As discussed above, in some examples, at least a portion or all of the nutritive sweetener may be added after step 114. In some examples, when nutritive sweetener is added following step 114, the mixture may be strained using a fine sieve to ensure that the mixture is free from any particles introduced by adding the nutritive sweetener. For example, when honey is used as the nutritive sweetener, the mixture may be strained or sieved to remove traces of honeycomb.

Step 116 includes cooling the mixture after a desired consistency and color are obtained to prepare the edible blood composition. In step 116, once a desired consistency and color are obtained as discussed above, the container used to prepare the edible blood composition is removed from heat and cooled. The edible blood composition may be cooled for at least 40 minutes. In some examples, the edible blood composition may be cooled in an ice bath. After observing that the edible blood composition has been completely cooled, the composition may be sealed and refrigerated.

In some examples, continuous mixing may be performed during certain steps of method 100 as discussed above. Further, straining of the mixture prior to cooling may be performed at various times throughout method 100 to remove visible particles that may contribute to the edible blood composition having an unrealistic appearance.

The above described method 100 for preparing an edible blood composition prepares edible blood compositions that may have a refrigerated shelf-life of approximately 10 days. For example, when packaged in a biodegradable material and tightly sealed, the edible blood composition may be preserved in a refrigerator at refrigeration temperatures of approximately 1° C. to approximately 4° C. In some examples, the edible blood composition of the present disclosure may be further processed to extend the shelf-life of the edible blood composition.

For example, after being prepared according to method 100, the edible blood composition may be packaged in a packaging material or container that is suitable for undergoing a preservation process. In certain examples, the edible blood composition may be treated like a jam and preserved according to a method that is similar to the process of “canning.” The edible blood composition may be packaged in a glass container (e.g., jar), sealed, and subjected to a heat treatment (e.g., boiling). In some examples, preserving an edible blood composition may include a heat treatment process using an air tight container (e.g., a glass container with a lid, a Mason jar, etc.). In these examples, after performing step 110 of method 100, the combined mixture may be strained by any suitable means (e.g., using a fine sieve) and in at least one example the nutritive sweetener may be added to the edible blood composition after it is strained in preparation for the heat treatment process using an air tight container. For example, an air tight container lid may be boiled for approximately 20 seconds and a glass bottom of the air tight container may be boiled for approximately 5 minutes. Once the air tight container and lid have been boiled, the edible blood composition obtained after straining the combined mixture comprising the thickening agent (e.g., cornstarch), cherry juice concentrate, aqueous hibiscus solution, cocoa powder, and nutritive sweetener may be filled into the air tight container and the air tight container containing the edible blood composition may be sealed with the lid. The sealed air tight container containing the edible blood composition may be submerged into boiling water, such that the water completely covers the air tight container, and boiled for approximately 10 minutes. After boiling for approximately 10 minutes, the sealed air tight container containing the edible blood composition may be removed from the boiling water and allowed to cool. Further, after removing the air tight container containing the edible blood composition from the boiling water, the lid of the container may pop to indicate that the edible blood composition has been properly sealed within the airtight container following the heat treatment process. After cooling, the edible blood composition contained in the air tight container is capable of being stored in a cool and/or dry place (e.g., a pantry). When performing a canning process to extend the shelf-life of the edible blood composition prepared according to method 100, certain steps in method 100 may be bypassed to ensure that the edible blood composition is only subjected to boiling once. For example, as discussed above, after step 110, the combined mixture may be strained and then added to an air tight container for heat treatment once the air tight container and lid have been boiled.

In other examples, the edible blood composition may be packaged and subjected to other processes which reduce oxygen levels and/or remove oxygen. For example, suitable oxygen scavengers or oxygen absorbers may be used. Further, exemplary packaging methods and/or techniques, which include but are not limited to, vacuum packaging, modified atmosphere packaging (e.g., adding nitrogen and/or carbon dioxide), controlled atmosphere packaging, micro-oxygen processing, and flushing with inert gases, may also be used. Such treatments may extend the shelf-life of the edible blood composition by about 6 to about 11 months. The resultant edible blood compositions may have a shelf-life between about 6 to about 11 months and may be stored outside of the refrigerator. For example, an edible blood composition that is subjected to a heat treatment method using an air tight container may have a shelf-life ranging from about 6 months to about 8 months. In at least one example, a source of pectin may be added to the edible blood composition to extend the shelf-life of the product. Pectin may be added to the edible blood composition prior to sealing and any further processing steps. In at least one example, agave may be added to the edible blood composition prepared according to method 100 prior to further shelf-life extension processing steps.

Preparing an edible blood composition according to the method 100 may include the use of any suitable thickener or thickening agent including, but not limited to, the cornstarch discussed above. According to the present disclosure, an edible blood composition may include a thickening agent selected from cornstarch, rice starch, tapioca flour, and tapioca starch. For example, an edible blood composition may comprise tapioca flour as the thickening agent. When tapioca flour or tapioca starch is used in preparing an edible blood composition according to the present disclosure, the steps of method 100 may be carried out with the tapioca flour or tapioca starch being used as the thickening agent in place of the cornstarch. In other words, tapioca flour or tapioca starch may serve as a substitute for the cornstarch in the method 100. Tapioca flour and tapioca starch have been found to provide more nutrients than a corn based product, and thus may be used to provide a healthier alternative to cornstarch.

Edible blood compositions according to the present disclosure may be packaged in sustainable (e.g., biodegradable) packaging materials. Exemplary packaging materials include, but are not limited to, glass containers, stainless steel, bamboo, rice husk, gelatin films, sugar cane, starch, and other recycled vessels.

According to an implementation of the disclosed subject matter, an edible blood composition may be prepared for animal consumption (e.g., for a dog, cat, etc.). One or more animals may not be able to consume ingredients applicable for human consumption such as hibiscus. Accordingly, subject matter disclosed herein provides techniques for preparing and/or storing edible blood for animal use.

The animal edible blood compositions of the present disclosure may mimic properties of real blood, with respect to appearance (e.g., color) and consistency. The animal edible blood compositions may be prepared from ingredients that may provide healthier options and nutritional benefits, while maintaining palatability, as compared to known edible blood compositions. The animal edible blood compositions may also prevent staining (e.g., staining of teeth, staining of fur, staining of hair, staining of skin, staining of clothing, etc.) and allow for repeated consumption and/or use, as compared to existing edible blood compositions

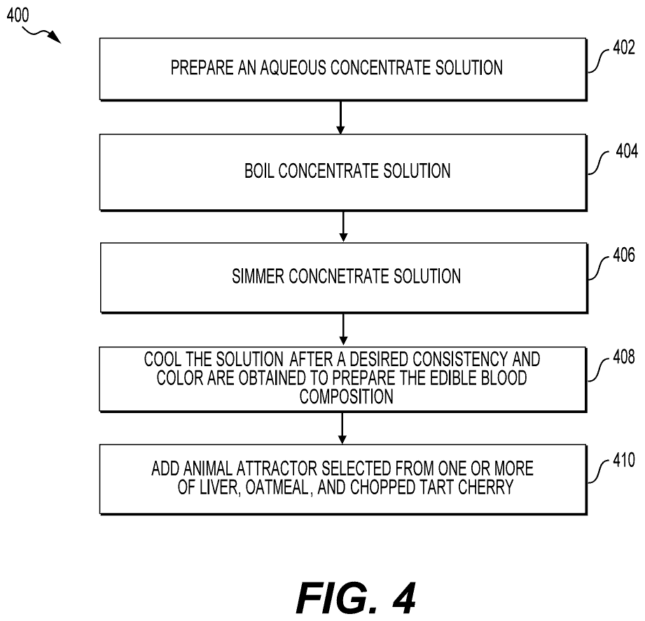

FIG. 4 is an exemplary embodiment of a flowchart illustrating a method 400 for preparing an animal edible blood composition.

In step 402, an aqueous concentrate solution is prepared. The aqueous concentrate solution may be prepared by combining water (e.g., alkaline water), tart concentrate, and cherry juice concentrate. The tart concentrate and the cherry juice concentrate may be derived from different cherry species. In some examples, the cherry juice concentrate may be a tart cherry juice concentrate (e.g., organic tart cherry juice concentrate). In these examples, the tart concentrate may be referred to as a first tart concentrate and the cherry juice concentrate may be referred to as a second tart concentrate. The first tart concentrate and the second tart concentrate may each be derived from a different cherry species. For example, the first tart concentrate may be a concentrate obtained from Montmorency cherry extract and the second tart concentrate may be a concentrate obtained from Balaton cherry extract or a mixture of Montmorency cherry and Balaton cherry extracts. In order to obtain the aqueous concentrate solution, water, tart concentrate, and cherry juice concentrate may be combined. In some examples, the water may be alkaline water or filtered water.

According to an implementation, the ratio of the water, tart concentrate, and cherry juice concentrate may be approximately one part water, approximately two parts tart concentrate, and approximately two parts cherry juice concentrate. The tart concentrate may be organic tart cherry juice concentrate. For example, the tart concentrate may be a Montmorency cherry juice concentrate. The cherry juice concentrate may be concentrated from sun-ripened Montmorency cherries and Balaton tart cherries and reconstituted with water.

The aqueous concentrate solution prepared at step 402 may be prepared by mixing the water, tart concentrate, and cherry juice concentrate in a mixing container. The solution may be mixed until a uniform color and/or consistency is reached.

At step 404, the aqueous concentrate solution prepared at step 402 may be heated to a boil. The aqueous concentrate solution prepared at step 402 may be heated in the same container used to mix the solution at step 402, or may be transferred to a separate container for heating to the boil.

At step 406, once the aqueous concentrate solution prepared at 402 is brought to a boil at step 404, the heat may be reduced to a low heat (e.g., as understood by one in the art). After the boiling point is reached, the temperature may be reduced to a simmer, for example, between approximately 85° C. to approximately 96° C. The resulting aqueous concentrate solution prepared at step 402 and heated to a boil at step 404 may simmer for approximately 22-28 minutes, resulting in a simmered solution.

The simmered solution may be tested using a testing object. The testing object may be any object with a surface conducive to be coated by the simmered solution. The testing object may be placed in and removed from the simmer solution and a coating of the color of the simmer solution may be detected. If a determination is made that the coating of the simmered solution is approximately a burgundy velvet solution such as, but not limited to, one or more of HEX color #610c0c, HEX color #5f0c00, HEX color #781601, or the like, then the simmered solution may be transitioned (e.g., removed from container, removed from heat, etc.) for cooling. The determination of the color coating may be made using techniques disclosed herein.

According to an implementation of the disclosed subject matter, cornstarch may be added to the solution transitioned following step 406, in accordance with techniques disclosed herein. The cornstarch may be added, for example, to lighten the color of the solution to a lighter solution, as discussed herein.

Step 408 includes cooling the resulting solution, which may comprise cornstarch added during transitioning, after a desired color is obtained to prepare the animal edible blood composition. At step 408 once a desired consistency and/or color are obtained, as discussed above, the animal edible blood composition is cooled. The animal edible blood composition may be cooled for at least approximately 40 minutes. In some examples, the animal edible blood composition may be cooled in an ice bath, a refrigerator, or other cooling component. After observing that the animal edible blood composition has been completely cooled, the composition may be sealed and refrigerated.

The method 400 for preparing an animal edible blood composition as described herein prepares animal edible blood compositions that may have a refrigerated shelf-life of approximately 10-14 days. For example, when packaged in a biodegradable material and tightly sealed, the animal edible blood composition may be preserved in a refrigerator at refrigeration temperatures of approximately 1° C. to approximately 4° C. In some examples, an animal edible blood composition prepared according to method 400 may be packaged, sealed, and stored (e.g., refrigerated) after step 408 and prior to step 410. In other examples, the animal edible blood composition prepared according to method 400 may be packaged, sealed, and stored (e.g., refrigerated) after step 410.

According to an implementation of the disclosed subject matter, at step 410, an animal attractor may be added to the solution transitioned following step 406 and/or cooled at step 408. In at least one example, at step 410, an animal attractor may be added to the edible blood composition after step 408. The animal attractor may be any applicable item that may increase the likelihood that an animal (e.g., a dog) allows or enjoys the application of the animal edible blood on or around the dog. For example, the animal attractor may be one or more of a pieces of meat (e.g., liver, organic meat, grass fed meat, etc.), oatmeal, pieces of a food item such as chopped tart cherry, or the like.

The animal attractor added at step 410 may change the color of the solution transitioned following step 406 and/or cooled at step 408. For example, adding oatmeal or liver pieces may darken the color of the solution transitioned following step 406 and/or cooled at step 408. Accordingly, an applicable amount of cornstarch may be added to lighten the color of the resulting solution. Additionally, adding the animal attractor at step 410 may reduce the shelf life of the resulting mixture to approximately three days. According to an implementation, step 410 may be performed within four hours of use of the resulting animal edible blood composition obtained from step 408. For example, an animal attractor, such as one or more pieces of meat (e.g., liver, organic meat, grass fed meat, etc.), oatmeal, and/or pieces of a food item, may be added to the animal edible blood composition resulting from step 408, directly prior to use. In at least one example, step 410 may be performed after the animal edible blood composition resulting from step 408 is removed from a refrigerator and unsealed in preparation for animal use.

In some examples, the animal edible blood composition of the present disclosure may be further processed to extend the shelf-life of the animal edible blood composition. For example, after being prepared according to method 400, the animal edible blood composition may be packaged in a packaging material or container that is suitable for undergoing a preservation process, as discussed herein.

The edible blood compositions of the present disclosure, including edible blood compositions for human consumption and edible blood compositions for animal consumption, are capable of being easily removed from the body (e.g., teeth) and/or clothing. As such, the edible blood compositions disclosed herein do not form a permanent stain and thus, may prevent staining. In some examples, the edible blood composition, such as the edible blood composition prepared according to method 100, may be completely removed from clothing upon cleaning. For example, when the edible blood composition contacts clothing, between about 90% to about 100%, between about 95% to about 100%, up to about 100%, etc., of the edible blood composition (e.g., a stain formed on the clothing by the edible blood composition) may be removed from the clothing when a soap and water mixture is applied to the clothing and the clothing containing the edible blood composition is rinsed with water. In some examples, when the edible blood composition contacts clothing and a stain is formed on the clothing, soaking the clothing in the soap and water mixture within an hour of contact may completely remove (e.g., between about 90% to about 100%, between about 95% to about 100%, up to about 100%, etc.) the stain from the clothing upon rinsing. In other examples, when the edible blood composition is left in contact with clothing for an extended period of time, such as more than a few hours or more than a few days, leaving a stain to settle in, the clothing may be subjected to a two-step cleaning process. First, the clothing may be soaked in a mixture of soap and water, followed by rinsing with cold water. In some examples herein, upon completion of the first cleaning step, up to approximately 85% of the edible blood composition stain may be removed from the clothing. Next, the clothing may be soaked in a cleaning solution comprising bleach, soap, and water for at least 5 minutes. In this step, the clothing may be scrubbed (e.g., lightly scrubbed) and rinsed to fully remove the stain. Upon completion of the second cleaning step, between about 95% and about 100% of the edible blood composition may be removed from the clothing, such that the clothing is free from an edible blood stain.

It will be understood that one or more techniques disclosed herein may be implemented in a similar or different manner than as disclosed herein. For example, one or more components or steps may be added or omitted in comparison to those described herein. Any order of steps describe herein is provided as an example only and one or more steps may be performed in a different order then that described herein.

### EXAMPLES

The following examples are intended to illustrate the present disclosure without, however, being limiting in nature. It is understood that the present disclosure encompasses additional embodiments consistent with the foregoing description and following examples.

### Example 1—Method of Preparing an Edible Blood Composition Comprising Cornstarch

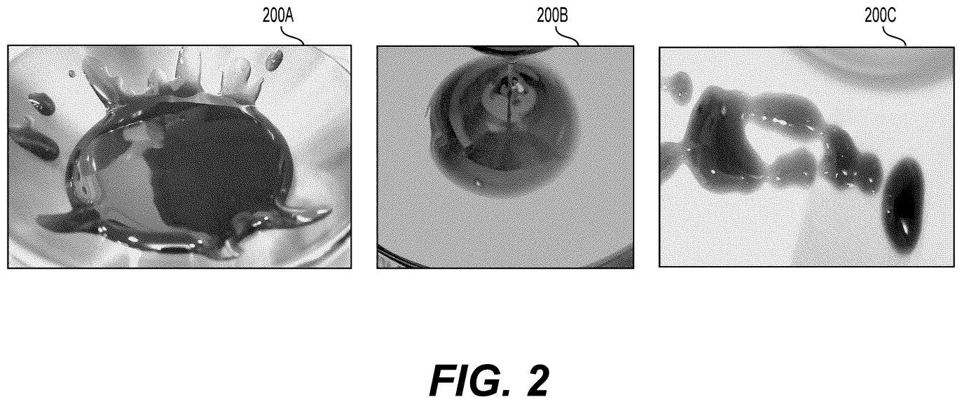

One gallon of water and 3 cups of hibiscus flowers were combined and brought to a boil. The combined mixture was simmered for 25 minutes on medium heat. After 25 minutes, the hibiscus flowers were strained out of the aqueous hibiscus juice using a fine strainer (cheese cloth), until the aqueous hibiscus juice was clear and free of particles. In a separate bowl, 9 tablespoons of cornstarch was sifted onto 2 cups of tart cherry concentrate, to prevent clumping, and mixed together. The cornstarch and tart cherry concentrate mixture was left to sit for about 5 minutes. The aqueous hibiscus juice was added back to the stove and heated to eventually bring it to a boil. Before the aqueous hibiscus juice was brought to a boil, 1 teaspoon of dark cocoa powder was added and stirred well. Then the cornstarch/tart cherry juice mixture was added to the hibiscus juice/cocoa powder mixture and stirred and whisked. Next, Manuka honey was added and stirred in well. The mixture was then brought to a boil to activate the cornstarch, while stirring. As soon as the mixture was brought to a boil, the mixture was removed from heating and subjected to straining using a fine sieve. Once the right consistency and color was obtained, the edible blood composition was cooled down in an ice bath. The edible blood composition produced is depicted in the images 200A, 200B, and 200C, shown in FIG. 2.

### Example 2—Method of Preparing an Edible Blood Composition Comprising Tapioca Flour

Four cups of water and 10 ounces of dried hibiscus flowers were combined and brought to a boil. The combined mixture was simmered for 20 minutes on medium heat. After 20 minutes, the hibiscus flowers were strained out of the aqueous hibiscus juice using a sieve, until the aqueous hibiscus juice was clear and free of particles. The hibiscus juice was strained through a sieve. In a separate bowl, 4 tablespoons of tapioca flour was sifted onto 6 ounces of condensed cherry juice, to prevent clumping, and mixed together. The tapioca flour and condensed cherry juice mixture was left to sit for about 5 minutes. The aqueous hibiscus juice was added back to the stove and heated to eventually bring it to a boil. Before the aqueous hibiscus juice was brought to a boil, ¼ teaspoon of dark cacao powder was added and stirred well. Next, 6 tablespoons of agave was added and stirred in well. Once the aqueous hibiscus juice began heating up, the tapioca flour/condensed cherry juice mixture was added to the hibiscus juice/dark cacao powder/agave mixture and stirred and whisked. The mixture was then brought to a boil to activate the tapioca flour, while stirring. As soon as the mixture was brought to a boil, the mixture was removed from heating and subjected to straining using a fine sieve. Once the right consistency and color was obtained, the edible blood composition was cooled down in an ice bath.

### Example 3—Method of Preparing an Edible Blood Composition Comprising Tapioca Starch

Four cups of water and 10 ounces of dried hibiscus flowers were combined and brought to a boil. The combined mixture was simmered for 20 minutes on medium heat. After 20 minutes, the hibiscus flowers were strained out of the aqueous hibiscus juice using a sieve, until the aqueous hibiscus juice was clear and free of particles. The hibiscus juice was strained through a sieve. In a separate bowl, 4 tablespoons of tapioca starch was sifted onto 6 ounces of condensed cherry juice, to prevent clumping, and mixed together. The tapioca starch and condensed cherry juice mixture was left to sit for about 5 minutes or about 20 minutes. The aqueous hibiscus juice was added back to the stove and heated to eventually bring it to a boil. Before the aqueous hibiscus juice was brought to a boil, ¼ teaspoon of dark cacao powder was added and stirred well. Next, 6 tablespoons of agave was added and stirred in well. Once the aqueous hibiscus juice began heating up, the tapioca starch/condensed cherry juice mixture was added to the hibiscus juice/dark cacao powder/agave mixture and stirred and whisked. The mixture was then brought to a boil to activate the tapioca starch, while stirring. As soon as the mixture was brought to a boil, the mixture was removed from heating and subjected to straining using a fine sieve. Once the right consistency and color was obtained, the edible blood composition was cooled down in an ice bath.

### Example 4—Method of Extending the Shelf-Life of the Edible Blood Composition of Example 1

An edible blood composition was prepared according to steps performed in Example 1, discussed above. After the cornstarch/tart cherry juice mixture was added to the hibiscus juice/cocoa powder mixture and stirred and whisked and the Manuka honey was added and mixed in well, the resulting edible blood composition was strained through a fine sieve. Next, 3 tablespoons of agave was added to the edible blood composition to aid in preservation. Mason jars and two part lids for each Mason jar were obtained. The Mason jar lids were boiled for 20 seconds. The glass bottoms of the Mason jars were boiled for 5 minutes. The edible blood composition was filled into each Mason jar and the lids were placed on each Mason jar after filling with the edible blood composition. The sealed Mason jar was completely submerged in boiling water and boiled for 10 minutes. After 10 minutes, the Mason jar was removed from the boiling water and allowed to cool. The process was repeated for each Mason jar to achieve a shelf life for the edible blood composition of approximately 6 months.

### Example 5—Method of Applying the Edible Blood Composition of Example 1

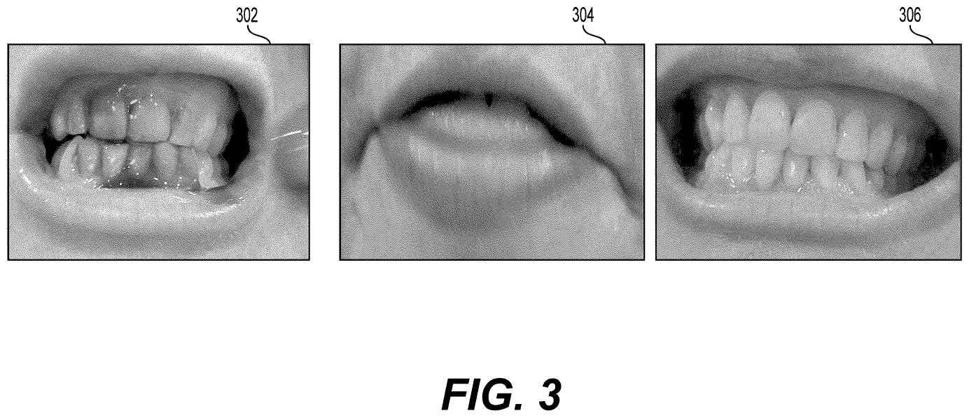

The edible blood composition prepared according to the method of Example 1, was applied to the teeth. The edible blood composition was wiped from the teeth, by running a tongue over the area where the edible blood composition was applied. Once the edible blood composition was wiped away, no trace of the edible blood composition was detected. FIG. 3 depicts the application step 302, the removal step 304, and the demonstration that the edible blood composition did not stain the teeth 306.

### Example 6—Method of Removing Edible Blood Composition of Example 1 from Cloth

The edible blood cornstarch containing composition of Example 1 was applied to a piece of white cloth and a deep red colored stain was formed on the cloth. The edible blood composition turned the white cloth red and the cloth was left to sit for 2 days. After 2 days, a soap and water mixture was prepared and the cloth was soaked in the soap and water mixture. After soaking in the soap and water mixture, the cloth was rinsed with cold water. The edible blood composition was observed as leaching away from the cloth during the rinsing. Once the rinsing was complete, more than half of the edible blood composition was removed from the cloth, as evidenced by a significantly lighter (e.g., pink) color on the cloth and a smaller stain covering a smaller surface area of the cloth compared to the initial stain formed by the edible blood composition.

Next, a cleaning solution comprising bleach, soap, and water was prepared. The cloth containing the remaining edible blood composition was added to the bleach containing cleaning solution and left to sit for approximately 5 minutes. After approximately 5 minutes, the cloth was lightly scrubbed and rinsed with water. During the scrubbing and rinsing, more of the edible blood composition was observed as leaching away from the cloth. Once the scrubbing and rinsing was complete, the cloth was restored to its original white color with no trace of the edible blood composition. The edible blood composition was completely removed from the cloth.

### Example 7—Method of Removing Edible Blood Composition of Example 2 from Cloth

The edible blood tapioca flour containing composition of Example 2 was applied to a piece of white cloth and a deep red colored stain was formed on the cloth. The edible blood composition turned the white cloth red and the cloth was left to sit for 2 days. After 2 days, a soap and water mixture was prepared and the cloth was soaked in the soap and water mixture. After soaking in the soap and water mixture, the cloth was rinsed with cold water. The edible blood composition was observed as leaching away from the cloth during the rinsing. Once the rinsing was complete, all of edible blood composition was removed from the cloth, as evidenced by the white color of the cloth with no trace of the edible blood composition present on the cloth.

### Example 8—Method of Removing Edible Blood Composition of Example 3 from Cloth

The edible blood tapioca starch containing composition of Example 3 was applied to a piece of white cloth and a deep red colored stain was formed on the cloth. The edible blood composition turned the white cloth red and the cloth was left to sit for 2 days. After 2 days, a soap and water mixture was prepared and the cloth was soaked in the soap and water mixture. After soaking in the soap and water mixture, the cloth was rinsed with cold water. Some of the edible blood composition was observed as leaching away from the cloth during the rinsing. Once the rinsing was complete, a small portion of the edible blood composition was removed from the cloth, as evidenced by a substantially similar red color on the cloth and substantially similar surface area coverage of the stain on the cloth after rinsing compared to the initial stain formed by the edible blood composition.

Next, a cleaning solution comprising bleach, soap, and water was prepared. The cloth containing the remaining edible blood composition was added to the bleach containing cleaning solution and left to sit for approximately 10 minutes. After approximately 10 minutes, the cloth was scrubbed and rinsed with water. During the scrubbing and rinsing, more of the edible blood composition was observed as leaching away from the cloth. Once the scrubbing and rinsing was complete, the cloth was restored to its original white color with no trace of the edible blood composition. The edible blood composition was completely removed from the cloth.

### Example 9—Method for Preparing an Animal Edible Blood Composition

One cup of alkaline water, two cups of tart concentrate (Simple Truth), and two cups of organic tart cherry juice concentrate (Dynamic Health) were mixed together. The mixture was brought to a boil and the heat was reduced to a simmer (between approximately 85° C. to approximately 96° C.) for 25 minutes. After 25 minutes, the product was testing by dipping a testing object into the product and removing the testing object to test the coat of the color of the product on the testing object. Once the right color was obtained, the animal edible blood composition was cooled down in an ice bath.

It will be understood that any measurement unites described herein (e.g., cups, gallons, teaspoons, tablespoons, ounces, etc.) may be normalized (e.g., to a common measurement unit) or otherwise converted from a first measurement unit to a second measurement unit. Further, it will be understood that a given measurement unit disclosed herein may expressed and applied as a normalized unit (e.g., one cup may be one unit). Further, it will be understood that a measurement disclosed as having a given measurement unit disclosed herein may expressed and applied as a ratio relative to another measurement having the same given measurement unit or a different measurement unit. For example, a tablespoon may be 0.0625 cups, 0.00390625 gallons, 3 teaspoons, etc. As another example, a cup may be 16 tablespoons, 0.0625 gallons, 48 teaspoons, etc. A gallon may be 16 cups, 256 tablespoons, 768 teaspoons, etc. As another example, an ounce may be 0.125 cups, 0.0078125 gallons, 2 tablespoons, 6 teaspoons, etc.

While principles of the present disclosure are described herein with reference to illustrative aspects for particular applications, the disclosure is not limited thereto. Those having ordinary skill in the art and access to the teachings provided herein will recognize additional modifications, applications, aspects, and substitution of equivalents that all fall in the scope of the aspects described herein. Accordingly, the present disclosure is not to be considered as limited by the foregoing description.

What is claimed is:

1. A method for preparing an edible blood composition, the method comprising:
preparing an aqueous hibiscus solution;
preparing a mixture of a thickening agent selected from cornstarch, tapioca starch, and tapioca flour and cherry juice concentrate;
heating the aqueous hibiscus solution;
adding cocoa powder to the aqueous hibiscus solution to form a mixture thereof;
combining the mixture of the thickening agent and cherry juice concentrate with the mixture of the aqueous hibiscus solution and the cocoa powder to form a combined mixture;
adding a nutritive sweetener to the combined mixture;
allowing the combined mixture to reach a boiling point to activate the thickening agent; and
cooling the combined mixture comprising the nutritive sweetener after a desired consistency and color are obtained to prepare the edible blood composition.

2. The method of claim 1, further comprising applying agitation after one or more of adding the cocoa powder, combining the mixture, or adding the nutritive sweetener.

3. The method of claim 2, wherein applying agitation comprises stirring, whisking, or a combination thereof.

4. The method of claim 1, wherein each step of adding cocoa powder, combining mixtures, and adding a nutritive sweetener is performed under heating.

5. The method of claim 1, wherein the nutritive sweetener comprises brown rice syrup, honey, or agave.

6. The method of claim 1, further comprising:
adding at least one of additional thickening agent or cherry juice concentrate to the combined mixture to obtain the desired consistency and color for the edible blood composition.

7. The method of claim 1, wherein cooling the mixture comprises placing a container retaining the edible blood composition in an ice bath.

8. The method of claim 1, wherein preparing an aqueous hibiscus solution comprises:
combining water and hibiscus flowers;
heating the combined water and hibiscus flowers to a boiling point;
allowing the combined water and hibiscus flowers to simmer for at least 15 minutes;
separating an aqueous component from the hibiscus flowers and any free particles; and
retaining the aqueous component for the aqueous hibiscus solution;
wherein separating is performed with a filter, a fine strainer, or a cheese cloth.

9. The method of claim 1, wherein preparing the mixture of cornstarch and cherry juice concentrate comprises sifting cornstarch onto the cherry juice concentrate and allowing the mixture to sit for about 5 minutes to about 20 minutes.

10. The method of claim 1, wherein combining the mixture of the thickening agent and cherry juice concentrate with the mixture of aqueous hibiscus solution and the cocoa powder comprises sifting the mixture of thickening agent and cherry juice concentrate into the mixture of aqueous hibiscus solution and cocoa powder, and continuously stirring and whisking the combined mixture.

11. The method of claim 1, wherein each step of adding the cocoa powder, combining mixtures, and adding the nutritive sweetener occur before the boiling point is reached.

12. The method of claim 1, further comprising:
packaging the edible blood composition in a container that is capable of maintaining a shelf life of at least 10 days.

13. An edible blood composition, the composition comprising:
hibiscus flowers;
water;
dark cocoa powder;
a thickening agent selected from cornstarch, tapioca starch, and tapioca flour;
cherry juice concentrate; and
a nutritive sweetener selected from honey, brown rice syrup, and agave.

14. The edible blood composition of claim 13, wherein the composition comprises:
3 to 4 cups hibiscus flowers;
1 gallon of water;
1 teaspoon dark cocoa powder;
from about 9 tablespoons to about 10 tablespoons cornstarch;
from about 2 to 3 cups cherry juice concentrate; and
8 to 10 tablespoons honey or 8 to 10 tablespoons agave.

15. The edible blood composition of claim 13, wherein the composition comprises:
10 ounces hibiscus flowers, wherein the hibiscus flowers are dried hibiscus flowers;
4 cups water;
¼ teaspoon dark cocoa powder;
4 tablespoons tapioca flour;
from about 2 to 3 cups cherry juice concentrate, wherein the cherry juice concentrate is condensed cherry juice; and
6 tablespoons agave or 6 tablespoons brown rice syrup.

16. The edible blood composition of claim 13, wherein the edible blood composition has a viscosity that mimics real blood in a range of about 3 centipoises to about 4 centipoises.

17. The edible blood composition of claim 13, wherein the composition is capable of preventing a stain from forming on teeth upon consumption.

18. A method of extending a shelf life of the edible blood composition of claim 14, the method comprising:
packaging the edible blood composition of claim 14 in a packaging material suitable for undergoing a preservation process; and
subjecting the packaging to heat treatment,
wherein the shelf life is extended by about 6 to about 11 months.

19. A method for preventing staining of teeth in a subject, the method comprising: applying the edible blood composition of claim 14 to teeth and wiping the edible blood composition from the teeth, wherein no trace of the edible blood composition is detected on the teeth after wiping.

20. A method for preparing an animal edible blood composition, the method comprising:
preparing a concentrate solution from 1 cup of alkaline water, 2 cups of tart concentrate, and 2 cups of tart cherry juice concentrate;
heating the concentrate solution;
reducing the heat when heating the concentrate solution results in a boil;
simmering the boiled solution; and
cooling the simmered solution to prepare the animal edible blood composition.

21. The method of claim 20, wherein the simmering the boiled solution comprises simmering the solution for between approximately 22 minutes and approximately 28 minutes.

22. The method of claim 20, further comprising adding an animal attractor to the animal edible blood composition.

23. The method of claim 22, wherein the animal attractor is one or more of a meat product, an oatmeal product, or a fruit.

24. The method of claim 22, further comprising adding cornstarch to the animal edible blood composition comprising the animal attractor.
